(19) United States
(12) Patent Application Publication
(10) Pub. No.: US 2016/0092995 A1
(43) Pub. Date: Mar. 31, 2016

(54) ACCOUNTING EXCHANGE AND AUTOMATED SETTLEMENT SYSTEMS AND METHODS

(71) Applicant: Hitendra Patil, Bangkok (TH)

(72) Inventor: Hitendra Patil, Bangkok (TH)

(21) Appl. No.: 14/869,991

(22) Filed: Sep. 29, 2015

Related U.S. Application Data
(60) Provisional application No. 62/056,947, filed on Sep. 29, 2014.

(51) Int. Cl. G06Q 40/00

(52) U.S. Cl. CPC G06Q 40/123

(57) ABSTRACT

Example embodiments include systems using computer hardware processors receiving user input and a master database storing transaction information. The processor receives transaction information from a buyer or seller and treats the transaction information based on desired formats and/or information in the master database. For example, the processor may transmit the transaction information to a buyer or a seller matching information in the transaction information or add additional information to the transaction information based on matched in the master database.

### BACKGROUND

Accounting software generally involves entry of data into the software interface from paper documents for financial transactions recorded or received by businesses. Such paper documents include invoices, bills, purchase orders, sales orders, credit memos, debit memos, checks, statements of transactions, etc. For example, in recorded financial transactions, a “receiver” generally sends an invoice to the “payer” when the receiver initiated transaction. When the payer initiates the transaction, the payer sends purchase orders to the receiver, and so on.

The flow of recorded financial transactions between receiver and payer is commonly paper-based, even though many paper documents can be faxed, scanned, emailed etc. Paper documents may offer a historically more accepted way of authenticating a transaction between payer and receiver, as an authorized personnel from a payer's or receiver's organizations may physically sign such papers as accepted proof of such transactions.

To record a transaction properly from such papers into the software accounting systems of both payer and receiver, it is necessary to enter data into accounting system of each of them. Therefore, a flow and cycle of financial transactions often occurs as follows. An initiator (payer or receiver) enters into their accounting system (creates data), then prints a document (converting data into paper), sends the printed document to a counterparty (receiver or payer) via fax, courier, scan and email, etc., the counterparty then enters the received document into their accounting system of the counter party (converting paper into data).

### SUMMARY

Example embodiments include systems using computer hardware processors receiving user input and a master database storing transaction information. The processor receives transaction information from a buyer or seller and treats the transaction information based on desired formats and/or information in the master database. For example, the processor may transmit the transaction information to a buyer or a seller matching information in the transaction information or add additional information to the transaction information based on matched in the master database.

Example methods perform automated exchange of accounting transactions between concerned entities and to settle such transactions within the accounting systems used by such concerned parties, without the need to enter the transaction data multiple times across such systems. Further, the objective of this system and method is to receive transaction data, match transaction data, validate transaction data, send transaction data, and perform a transaction using various entities who are participants in this system and method. Example systems and methods may provide an accounting exchange system which is configured to automatically receive, authenticate, match, validate, exchange, and settle a transaction once created at any originating point into the logical end point i.e. accounting system of the counterparty lies. Example accounting exchange systems may allow for each entity with accounting needs and with accounting transactions to establish electronic connectivity with several counterparties at the same time and receive and send data on periodic basis to such several counterparties.

Example systems and methods may provide an accounting exchange system which is a central entity i.e. a central computerized system for several entities, which several entities are enabled and configured to connect to the accounting exchange system with just one connectivity and is further designed and enabled to receive, authenticate, match, validate, exchange, and settle a transaction once created at any originating point into the logical end point i.e. accounting system of the counterparty. Example systems and methods may provide an accounting exchange system which would save countless man-hours of efforts across the globe, in terms of accounting and book-keeping, thereby reducing the cost of settling transactions significantly, thereby creating tangible cost benefits to all stakeholders that use any accounting system.

When users use example systems and methods, they have the choice to use it as a normal accounting system with or without the choice of using this system to automatically settle their transactions with the respective counterparties. This system further enables all stakeholders in the accounting ecosystem, e.g. sellers, buyers, vendors, banks, suppliers, accountants, tax preparers to send and receive transactions to counterparties wherein the transactions appear in the users' native accounting systems in order to accept and confirm or reject. Such transactions that move through native accounting systems are automatically coded with the correct chart of accounts codes so that proper accounting is done with the aid of system validated artificial intelligence to minimize the human errors and time and hence costs associated with accounting.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of an example embodiment settlement system system.

FIG. 2 is an illustration of an example embodiment settlement system networked with several buyer and seller counterparties.

FIG. 3 is a flow chart illustrating flow and compiling of information in example embodiment settlement system using a transmission rules engine.

FIG. 4 is a diagram of information flow through a master database in a transmission rules engine.

FIG. 5 is a flow chart of an example method.

FIG. 6 is another flow chart of an example method.

FIG. 7 is another flow chart of an example method.

### DETAILED DESCRIPTION

This is a patent document, and general broad rules of construction should be applied when reading it. Everything described and shown in this document is an example of subject matter falling within the scope of the claims, appended below. Any specific structural and functional details disclosed herein are merely for purposes of describing how to make and use example embodiments. Several different embodiments not specifically disclosed herein may fall within the claim scope; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when element(s) are referred to in relation to one another, such as being “connected,” “coupled,” “mated,” “attached,” or “fixed” to another element(s), the relationship can be direct or with other intervening elements. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). Similarly, a term such as “connected” for communications purposes includes all variations of information exchange routes between two devices, including intermediary devices, networks, etc., connected wirelessly or not.

As used herein, the singular forms “a”, “an,” and “the” are intended to include both the singular and plural forms, unless the language explicitly indicates otherwise with terms like “only a single element.” It will be further understood that the terms “comprises,” “comprising,” “includes,” and/or “including,” when used herein, specify the presence of stated features, values, steps, operations, elements, and/or components, but do not themselves preclude the presence or addition of one or more other features, values, steps, operations, elements, components, and/or groups thereof.

It should also be noted that the structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations. It should be presumed that any embodiment having features and functionality described below, in any workable combination, falls within the scope of example embodiments.

The following co-owned applications are incorporated by reference herein in their entireties: U.S. Application 62/056,947 to Patil filed Sep. 29, 2014. The example methods and embodiments of the incorporated documents are useable in whole and in part in addition to, or in replacement of, example systems and methods, including individual components, elements, structures, steps, connections, actions, data structures, functionalities, etc. thereof.

The inventor has recognized a repeating cycle of converting data into paper and then converting paper back into data in existing accounting systems of counterparties requires repetitive manual effort that consumes time and costs money. Given the large number of transactions that take place between any two entities in real time, the time lost and the costs of recreating same data in counterpart systems is large. The inventor has recognized that in related computerized accounting systems, there are no practical and cost effective ways of exchanging, authenticating, and settling transaction data between accounting systems of any two counterparties. Each party typically maintains and enters its business transactions into its own accounting database. Due to the independent nature of accounting databases, it is thus difficult to create and update multiple accounting databases simultaneously and to a same effect among any number of counterparties for any transaction. Further, as there is no simultaneous, shared authentication between counterparties for each transaction, discrepancies and errors in recording transactions more readily occur. Such recording delays and errors result in payment delays for goods and services bought and received, increasing operating costs for most businesses.

The inventors have further recognized that connecting each party and counterparty to a shared accounting database requires multiple electronic connectivity channels, and difficult synchrony among accounting software. Such maintained connectivity and synchrony exposes businesses to security risks due to such compatibility and access. With different data and technology standards followed by different parties, there is no single common way to safely exchange data with any given counterparty unless the transaction data is converted first into a secure format, which itself exposes data to errors of omission and commission. The below disclosure uniquely enable solutions to these and other problems recognized by the inventors in computerized healthcare information networks handling huge amounts of healthcare data.

The present invention is computer networks, software, and/or hardware that. While general accounting practices are useable with the present invention, the inventor expressly disclaims any scope over accounting principles per se, in the abstract, and as conventionally applied. In contrast to the present invention, the few example embodiments and example methods discussed below illustrate just a subset of the variety of different configurations that can be used as and/or in connection with the present invention.

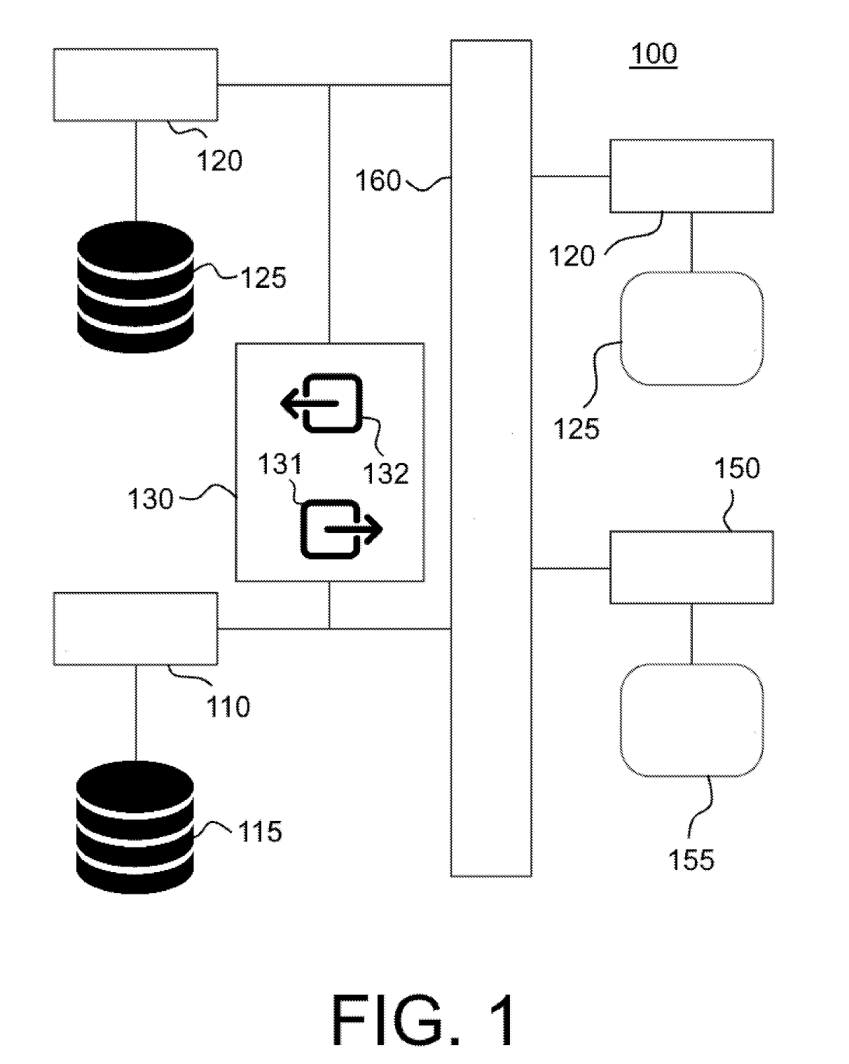

FIG. 1 is a schematic diagram of an example embodiment accounting exchange system 100. Example embodiment system 100 may be implemented in hardware specially, physically configured for each function and element, or example embodiment system 100 may be implemented in a general purpose computer through specific software programming that transforms the computer's processor, transient memory, persistent memory, bus, and communicative interfaces into the functions and elements of example system 100. Regardless of implementation, example embodiment accounting exchange system 100 is configured to receive and process transaction information between at least two counterparties to the transaction.

The following terms may be useful to understand operation of example embodiment system 100. The terms payer and buyer, may be understood as an entity which pays for a deliverable, such a service, advice, goods, or any other right from a receiver or seller. For example, a payer may agree to pay with currency or other consideration in exchange for a product, goods, and/or service from the receiver. The term receiver may be understood as the entity which pays for such deliverables to the payer and, in turn, receives the payments or consideration from the payer. The term counterparties may be understood as people, businesses, organizations and/or other entities who transact between themselves and initiate, execute, and/or settle a transaction between themselves. Generally, each transaction will have at least two counterparties.

The term electronic format may be understood as information in such format which can be readable by machine and/or computer, including fixed readable media such as optical discs, RAM, ROM, magnetic tape, etc., and electronic format explicitly does not include a transient or propagating signal per se. For example, both the payer and receiver may engage in financial transactions manually or automatically where the transaction data is in electronic format. The term function may be understood as an action performed by software or configured hardware based on rules defined in the software (as natively stored, as generated upon execution in memory, and/or as according to data entered by counterparties) as well as in hardware physical structure.

The term transaction may be understood as an entry of relevant information about an instance of exchanging products, goods, services, other rights, and/or consideration between payer and receiver in example embodiment system 100. The term accept may be understood as an action performed by a user of example embodiment system 100 and method to review received financial data or a transaction and expressly entering an acceptance through example system 100. The related term approve, however, may be understood to uniquely refer to an action performed by the user of example embodiment system 100 and method to confirm the accepted data/transaction and to release acceptance information to the counterparty of the transaction and/or to download the transaction data into the user's accounting system.

The terms bank statements and credit card statements may be understood as statements of transactions/account activity issued by banks and/or credit card providers. The term deliverable may be understood as goods, services, right, and/or any other thing that the receiver of consideration promises to deliver. The term, settling (transactions) may be understood as matching, validation, acceptance, and/or approval of transaction data between two counterparties to a transaction within example embodiment system 100. Transfer of money or consideration for the transaction may or may not occur within example embodiment system 100 during settling.

((For the purposes of this invention, the term, ‘Structure’, refers to the system as data exchange, matching and validation system that exchanges and matches and validates the data based on several parameters within the system and makes the validated data available to the concerned entity for its use.))

As shown in FIG. 1, example embodiment accounting exchange system 100 includes a payer registration module 110 that provides registration for payers to register and access the system, methods, platform, and exchange of an example embodiment accounting exchange system 100. For example, module 110 may be a software routine that instructs a computer program to access, store, or verify payer credentials, history, profile, and other information. Payer registration module 110 is communicably coupled with a payer database 115 that persistently stores payer information, such as authentication and history information used by module 110 all future transactions. Information about any payer may be written and stored in database 115 for future use.

A receiver registration module 120, similar to registration module 110, provides registration for receivers to register and access the system, methods, platform, and exchange of an example embodiment accounting exchange system 100. For example, module 120 may be a software routine that instructs a computer program to access, store, or verify receiver credentials, history, profile, and other information. Receiver registration module 120 is communicably coupled with a payer database 125 that persistently stores receiver information, such as authentication and history information used by module 120 all future transactions. Information about any receiver may be written and stored in database 125 for future use.

An interface 130 may connect to modules 120 and 110 for user access to example embodiment system 100. For example, interface 130 may include a touchscreen, keyboard, remote computer, terminal, telephone, etc. that permits users to interface with system 100, potentially with separate GUIs, interfaces, and machines provided between a payer interface 131 and a receiver interface 132. Through interface 130, users, including payers and receivers may access and input transaction information as well as execute example methods including login, authentication, approval, acceptance, etc. of financial transactions. Interface 130 may further permit a user to import or update or enter statements of advice, including bank statements, credit card statements, loan statements, and the like statements. Such inputs may be approved, analysed, processed and otherwise stored, potentially in association with the user, in example embodiment system 100.

A transmission module 150 provides data transmission between nodes of example embodiment accounting exchange system 100, essentially providing communications amongst additional iterations of system 100. Transmission module may include a rules engine 155 that conditions transmission of financial and transaction information within example system 100.

As shown in FIG. 1, an approval module 120 is configured to approve transmission of transaction data, such as through transmission module 150. An approval rules' engine 125 may be operable with approval module 120 to define approval rules and further condition terms under which transaction data is shared and transactions settles. For example conditions for approval may be pre-defined in approval rules engine 125 such that approval may be automated for certain pre-defined parameters relating to transmission and transaction.

Of course, approval may also be human-user-dependent, such as from user approval received from interface 130. For example, approval module 120 is communicably coupled to interface 130, wherein each seller and receiver can access and review transaction data before importing, updating, or exporting transactions data to or from their own accounting systems. Approval module 120 may include pre-defined templates in which transaction data is automatically populated and stored in a pre-defined format, potentially depending upon the initiator and nature of transactions. For example, one format may allow users to review and approve a transaction through interface 130 in a single or few clicks without the need to enter all transaction data at each step or transaction.

As an additional example of the programming and control of approval module 120, when a transaction is created by one entity in example system 100, it may be accepted by the other entity. At such a juncture, approval module 120 may provide necessary transaction data to the seller and receiver to move the transaction to the next logical step within their accounting systems (or within example embodiment system 100), including details of the accepted transaction and terms or description of deliverables and considerations. In this way, accounting transactions and entry requirements of the same may be minimized, and same validated and authenticated data may be provided to relevant counterparties.

As shown in FIG. 1, example embodiment accounting exchange system 100 includes a connection interface 160 configured to connect the system, methods, platform, and exchange of the example embodiment system 100. Connection interface 160 may include one or more networked processors, co-located or remote, to control operation of system 100, including interface 130, transmission module 150, transmission rules engine 155, registration modules 110 and 120, approval module 120, and/or approval engine 125. For example, with associated memory and bus, connection interface 160 may be programmed to execute example methods and make operable the functionality of various modules described in connection with system 100. Connection interface 160 may further be configured with hardware and/or software to communicate with native or existing accounting systems of the counterparties.

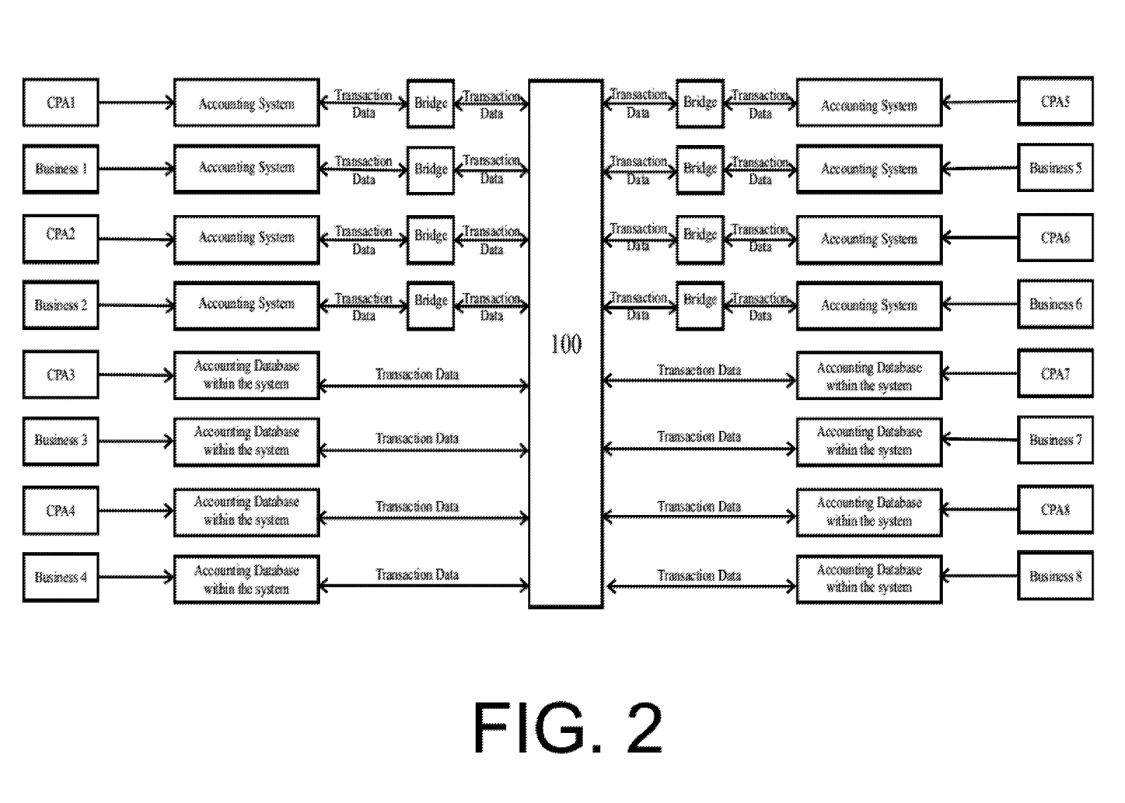

FIG. 2 is an illustration of example embodiment accounting exchange system 100 schematically operating among several users' transaction systems. As seen in FIG. 2, transaction data may be exchanged and validated from example system 100 based on pre-defined parameters in a validated manner among concerned entities, without entering transaction data separately in each entity's individual Accounting System or Accounting Database. Example embodiment system 100 may be compatible with, and supplement such independent Accounting Systems/Databases such as QuickBooks, PeachTree, and the like.

As seen in FIG. 2, CPA1 to CPA8 may be Certified Public Accountants, such as individual CPAs or accounting firms. Business1 to Business8 may be multiple, independent entities, such as individuals or firms that enter into, or desire to enter into, financial transactions with each other as sellers and receivers and need to maintain books of such transactions. In the example of FIG. 2, Business1 is a counterparty to a transaction with Business5; Business2 with Business6; CPA1 with CPA5; etc. Transaction Data passed among the Accounting Systems and example embodiment system 100 may include details about accounting transactions that need to be present in the accounting databases of both counterparties to a given transaction.

A Bridge may be present between example embodiment system 100 and Accounting Systems and Databases of receiver and seller counterparties. Bridge may be a sub-module or a separate structure, such as a separate server and processor, within or outside example system 100 that still interacts with core engine 160 (FIG. 1) and Accounting Databases. Bridges may be configured to convert transactions data from accounting databases outside example embodiment system 100 into such a format as may be needed to match and validate counterparties, in order to settle transactions with verified counterparty lies. Bridges may further convert Transaction Data matched and validated among counterparties into a format for export into Accounting Databases within the control of settling parties. Bridges may further integrate the flow of Transaction Data to and from Accounting Databases outside system 100 so that a user does not have to manually handle Transaction Data files imported into or exported from users' Accounting Systems and Databases.

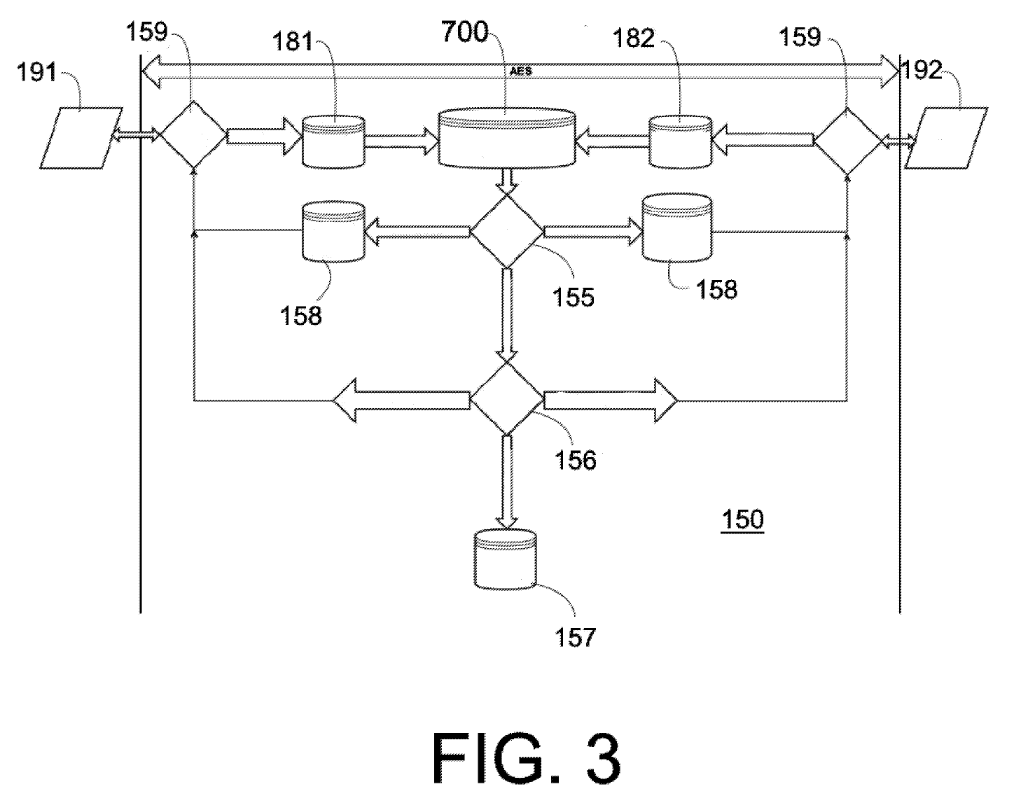

FIG. 3 is a schematic of information and operations control using transmission module 150 and associated rules engine 155 of FIG. 1. As seen in FIG. 3, transmission module 150 is configured configured to transmit data from one node to another node within an example embodiment system, where nodes may be ports, interfaces, or connections between counterparty payers and receivers. Transmission rules engine 155 defines rules for transmission of data in terms of matching data between counterparties. Additional transmission rules engine 156 may provide further matching probabilities to define rules for transmission of data in terms of partially-matched data between counterparties. Unmatched transactions database 157 may store data relating to transactions and counterparties where transactions have failed between counterparties due to non-matching. Matched transactions' database (MTDB) comprises data relating to transactions and counterparties where transactions have been matched between counterparties.

Flow across counterparties to a related art transaction can be visualized by the following chain of actions: Seller decides to sell→Agreement to purchase terms by buyer→Entry of sell transaction details into accounting system→Convert accounting transaction data into paper or electronic form to deliver to buyer→Buyer receives paper or electronic data→Buyer verifies terms and details and accepts if all ok→Buyer enters transaction data into its own accounting system. The reverse is also a normally occurring related art transaction in accounting: Buyer decides to buy→Agreement to terms of Seller→Entry of buy transaction details into accounting system→Convert accounting transaction data into paper or electronic form to deliver to seller→Seller receives paper or electronic data→Seller verifies terms and details and accepts if all ok→Seller enters transaction data into its own accounting system. As seen, data is converted back-and-forth between paper and counterparties' electronic systems in these flows. Where different accounting systems are used by buyers and sellers, each buyer and seller entity and/or their accountants need to manually adapt data for each individual system.

As seen in FIGS. 1 & 3, example systems and methods authenticate, validate, and/or exchange accounting transactions data between buyers and sellers i.e. counterparties to respective transactions, in a reliable way that does not require manual or individual adaptation and reconversion of paper to electronic records. Transmission module 150, using transmission rules engine 155, may verify and match counterparties using EIN or Tax ID details from independent, publicly-available or purchasable databases as well as address, phone numbers, transaction details including purchase or sell order numbers and so on. With several data elements and match identifications to identify counterparties reliably, transaction data may be segregated, extracted, and delivered to correct counterparties. Transmission rules engine 155 may further account for counterparty's own set of matching and acceptance rules in identifying proper counterparties, such as a parties' input of a correct counterparty's name or Tax ID.

Transmission rules engine 155 may further create and deliver transaction data in format to a verified counterparty through transmission module 150 so that each counterparty to the transactions can simply accept, modify and accept, or reject such data into their own accounting systems, without the need to re-enter transaction data into their own respective accounting systems.

Transmission rules engine 155 may be continuously updated for matching parameters and rules, including chart of account codes used by sellers and buyers with their own accounting systems. For example, aggregated party and transaction data may be stored in master database 700. In this way, transmission engine 155 may build a knowledge repository 700 that users may consult to quickly determine which accounting codes best match particular transactions, based on marketwide statistics about types of goods and services and most commonly used account codes. This repository in transmission rules engine 155 helps improve the quality of accounting itself by providing market-wide qualitative accounting knowledge and improving regulatory compliance.

Transmission rules engine 155 may act as an accounting exchange system by providing correct identification of counterparties to transactions, delivering accounting information to correct counterparties to enable them to update their own accounting databases without needing to enter data into the same. Transmission Rules Engine 155 may include or control a processor acting under directions of executed software using comparisons to identify correct counterparties.

For example, transmission rules engine 155 may use and match one or several identifier data values uniquely associated with any entity with data entered by the counterparty payer or receiver. For example, an identifier may be Employer Identification Number and/or Social Security Number and/or AES Unique Identification Number (AESUIN), amongst other such identifiers as may be defined into the AES-TRE as the regulatory changes of the country/ies create for the proper functioning of the accounting and financial industries. Further, transmission rules engine 155 may use multiple combinations of publicly identifiable and verifiable data elements such as the data (name, address, phone, website, etc.) used by any entity while registering with governmental regulators, social media accounts, OpenID databases, Bank Account Number Verifications, etc. to properly identify and match counterparties.

Using identification data, transmission rules engine 155 may take several actions in example methods to verify counterparties. For example, using FIG. 3, a payer 191 may upload, either directly through a system interface 130 or via bridge 161, its accounting transactions 181, counterparty data such as EINs, SSNs, or AESUINs and deliverable or consideration data, for example, item code, item description, chart of accounts code, quantity, unit rate, amount (quantity multiplied by unit rate), tax if any, etc. as is required for receiver 192 to accept the transaction into its own accounting system.

Transmission rules engine 155 may match any or all of such data from the payer 191 with data in master database 700. Where counterparty EIN, SSN, AESUIN, or other identification or additional matching criteria such as name of the counterparty or bank account number of the counterparty or the phone number of the counterparty etc. match, the matched parties are segregated according to the counterparty identification matched and combined into a data file to be delivered to each counterparty.

Unmatched transactions may be compared against other available data fields, for example using additional transmission rules engine 157 and/or data in master database 700, to identify additional likely matching parties for submitted transactions. Additional matching may use one or more unused data fields. For example, counterparty EIN may not be in data 181 uploaded by payer 191 but a phone number of the counterparty may be. The phone number may match with the phone number of a counterparty data from master database 700 to identify and verify the counterparty, and so on. Such partial matches, matches using unreliable information, or other matches that are not verified as correct may be relayed back to payers 191 to reconfirm by enriching data 181 with corrected identifiers. Or the matching transaction may be relayed to the probable receiver 192 to accept or reject.

At the end of each cycle of transactions transmission and matching, the transactions may be fully matched and accepted by both counterparties; fully matched but rejected by counterparties; partially matched, enriched by users and then accepted as fully matched; or partially matched but rejected by the counterparties.

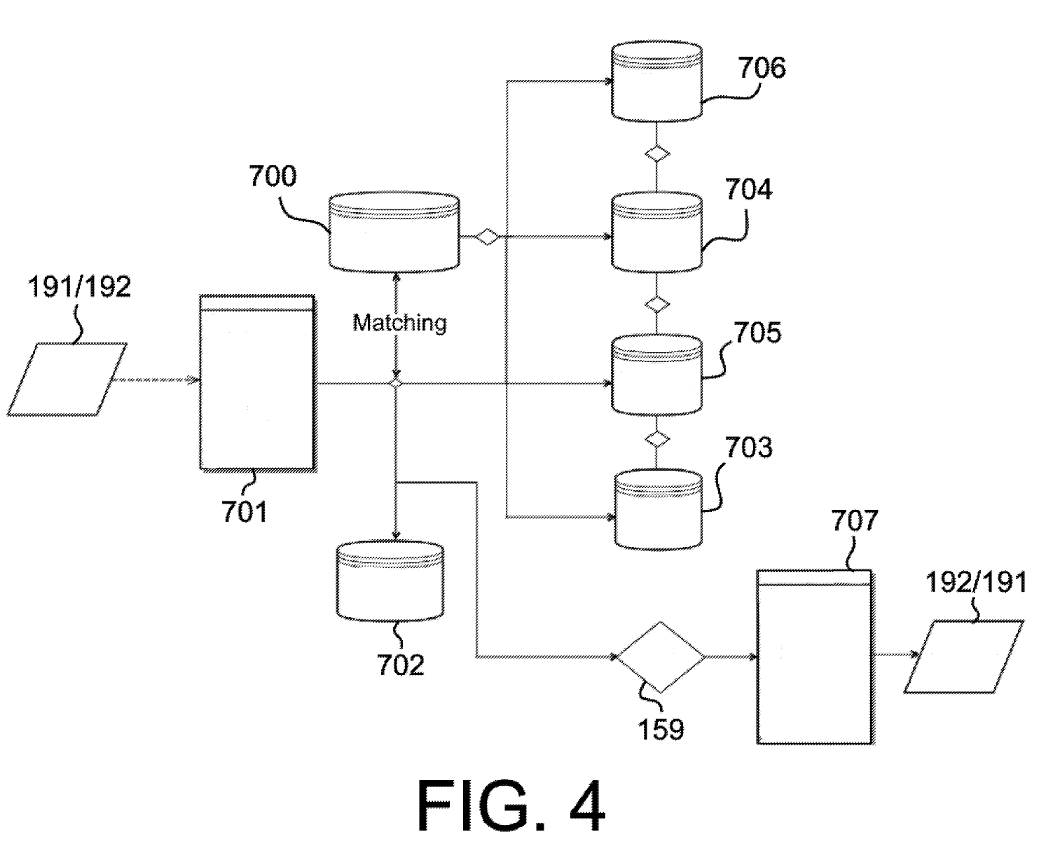

FIG. 4 is a detailed schematic of master database 700 showing various pieces of information storable therein and relatable through several different associations. As shown in FIG. 4, each entity, whether payer or receiver or other inquirer, may have a unique identifier that can be used to relate any transaction data to the entity in example methods and systems. These identifiers may be used to verify counterparties to each submitted transaction.

Because database 700 may store a variety of pieces of information about parties, either from party-submitted transaction data or publicly-available or acquirable sources, a relatively accurate identification of any payer or receiver 191/192 may be made for directing transactions and further correcting and enhancing user information. Such improved information in master database 700 may further use be delivered to payer or receiver 191/192 to automatically update their accounting databases, whether within or outside example embodiment system 100, without manual re-entry of transaction data into their own accounting databases.

Such improved transaction data comprehensively matched with sellers and receivers in database 700 may further maintain an identification of goods or services 703/704 involved in any transaction and corresponding account codes 705 used for each item, in such multiple relational databases that identify combinations of entity and item, similar items across the entire database etc., record transaction frequency 706, and/or store relational data from every transaction. For example, each good or service 703/704 from each transaction may be stored against a type of item (expense, asset etc.), accounting code identifiers 705 as used by each entity, price per unit, quantity etc. From such information, sellers and receivers may be suggested commonly used chart of account codes for each transacted item input into example system from information in database 700. In this way, time required to select and use appropriate accounting codes may be reduced while improving coding accuracy. This “system intelligence” is possible because of the unique centrally maintained database 700 in example embodiment system, 100, in transaction module 150.

As shown by the flow in FIG. 4, input transactions 701 may be compared against any or all of the information in master database 7090 to enhance data in transactions 701 and determine best recipients for settling the same. Once enhanced and potentially corrected by the inputting user 191/192, the correctly matched transaction 707 may be provided to the accurate recipient 191/192 with full transaction information in a format automatically uploadable by the recipient. In this way, master database 700 databases may be created and maintained to identify correct counterparties to the transactions, identify and suggest commonly used accounting codes for each of the item, prompt users to verify and add additional information for partial matches or incorrect entries, accurately deliver transaction data to counterparties, and update each user's individual databased with correct information.

The following is an example method of using example system 100 (FIG. 1), employing the information flow and enhancements of FIGS. 3 and 4. For example, a seller 192 may provider a sales invoice or a bill that includes a transaction number, customer identity (in the accounting system of the seller), tax identity (of the seller and/or the buyer/payer in the accounting system of the seller), customer name, item identity(ies), item description(s), quantity(ies) or unit(s) sold, rate per unit, total amount of each item, total amount for the invoice, tax amount for the invoice, and the like parameters. Payer 191 may similarly provide a purchase order including transaction number, vendor identity (in the accounting system of the payer), tax identity (of the seller and/or the buyer/payer in the accounting system of the payer), vendor name, item identity(ies), item description(s), quantity(ies) or unit@) sold, rate per unit, total amount of each item, total amount for the invoice, tax amount for the invoice, and the like parameters. Payer 191 and buyer 192 may so provide orders simultaneously for a same transaction, or individually. Payer 191 and seller 192 may further provide mere statements of advice.

Transmission module 150 and transmission rules engine 155 may match and validate the received transaction data based on at least one matching parameters defined in master database 700, and provides the counterparty of such matched transactions such data/information as may be necessary to update their accounting systems.

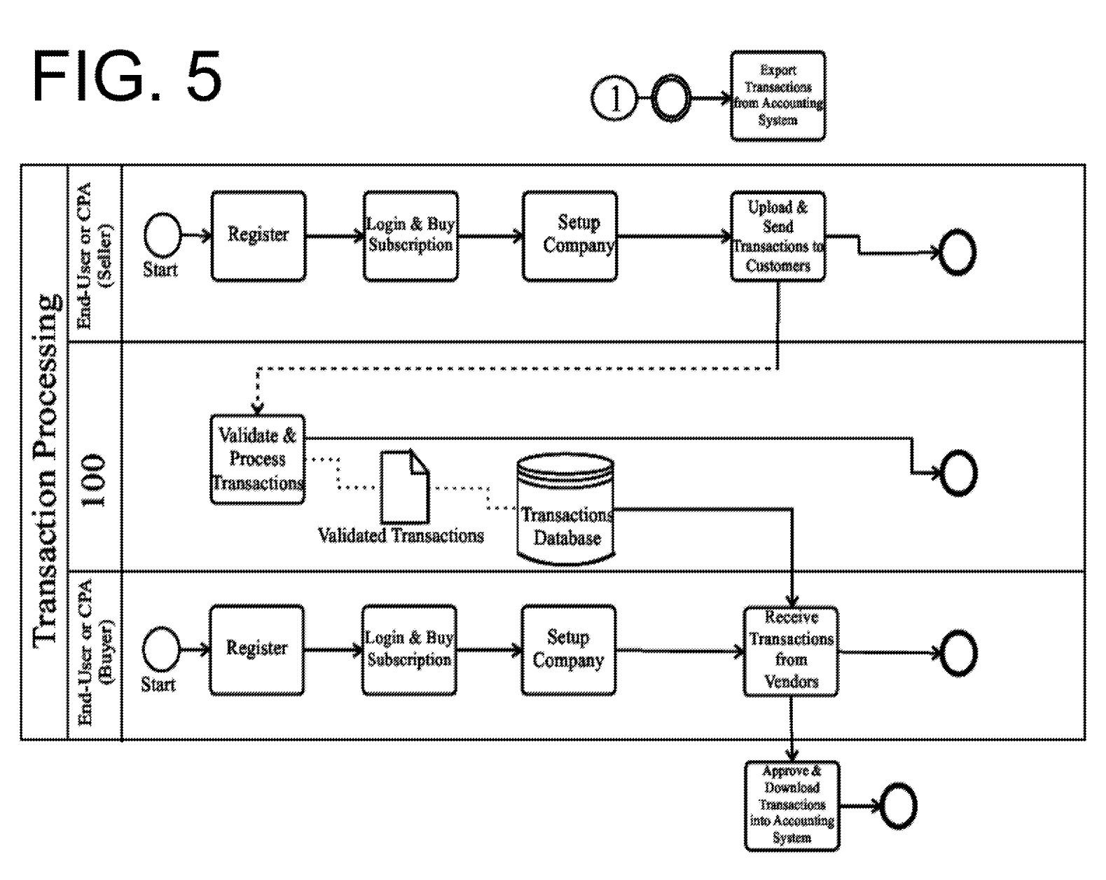

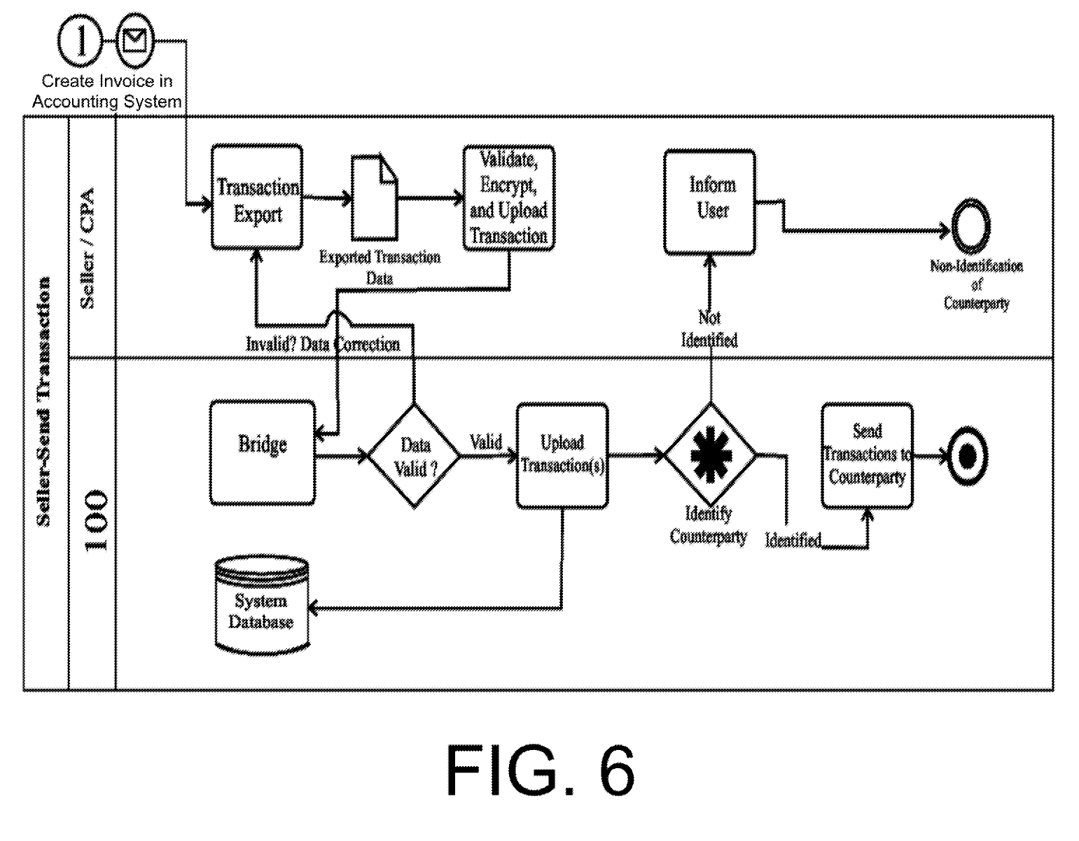

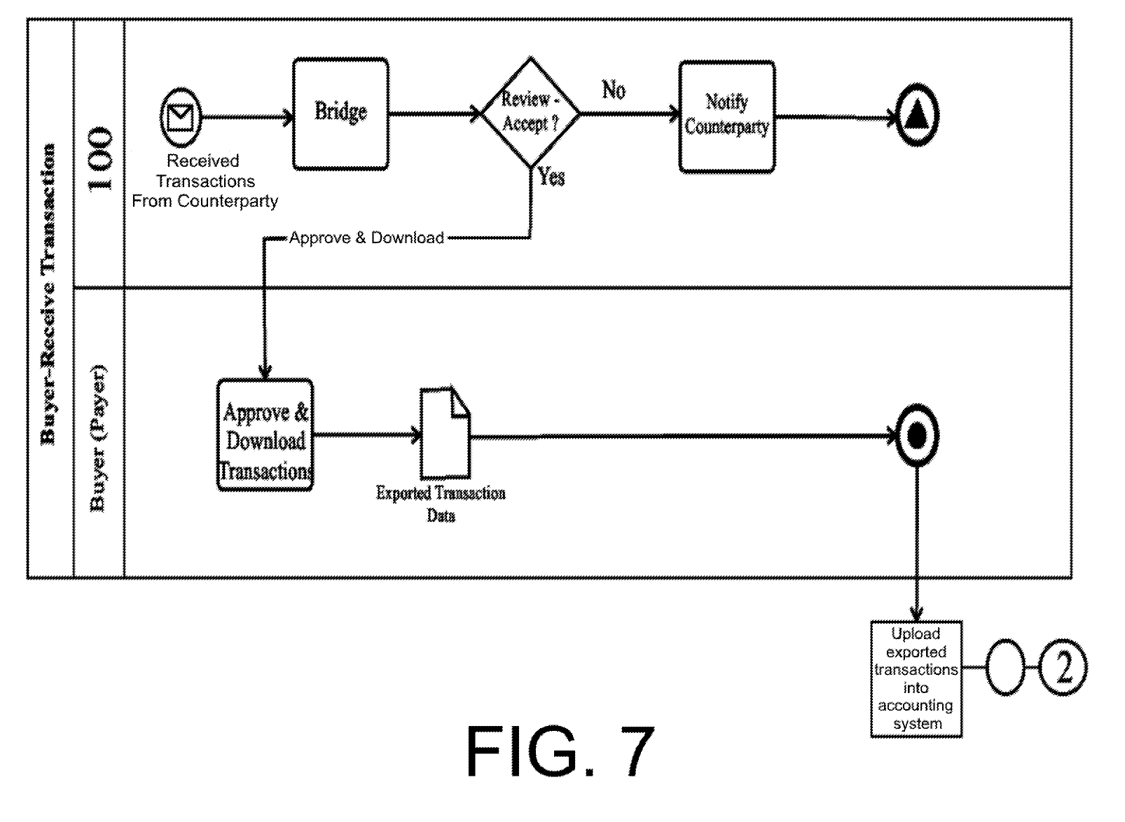

FIGS. 5-7 illustrate a typical transaction flow using example systems and methods, with existing or individual users' accounting systems or databased being labelled with “1” or “2”. FIG. 5 illustrates a flow and interaction between both buyer and seller; FIG. 6 illustrates a flow for a seller only; and FIG. 7 illustrates the flow for a buyer only. As seen in FIGS. 5-7, relatively few actions may be required for a user to receive/send properly-matched and enhanced transaction data and settle a transaction.

The data, in each of the components of the strategic survey and feedback system and method may be ‘encrypted’ and suitably ‘decrypted’ when required. Encryption can be accomplished using any encryption technology, such as the process of converting digital information into a new form using a key or a code or a program, wherein the new form is unintelligible or indecipherable to a user or a thief or a hacker or a spammer. The term ‘encryption’ includes encoding, compressing, or any other translating of the digital content. The encryption of the digital media content can be performed in accordance with any technology including utilizing an encryption algorithm. The encryption algorithm utilized is not hardware dependent and may change depending on the digital content. For example, a different algorithm may be utilized for different websites or programs. The term ‘encryption’ further includes one or more aspects of authentication, entitlement, data integrity, access control, confidentiality, segmentation, information control, and combinations thereof.

The systems described herein can be made accessible through a portal or an interface which is a part of, or may be connected to, an internal network or an external network, such as the Internet or any similar portal. The portals or interfaces are accessed by one or more of users through an electronic device, whereby the user may send and receive data to the portal or interface which gets stored in at least one memory device or at least one data storage device or at least one server, and utilises at least one processing unit. The portal or interface in combination with one or more of memory device, data storage device, processing unit and serves, form an embedded computing setup, and may be used by, or used in, one or more of a non-transitory, computer readable medium. In at least one embodiment, the embedded computing setup and optionally one or more of a nontransitory, computer readable medium, in relation with, and in combination with the said portal or interface forms one of the systems of the invention. Typical examples of a portal or interface may be selected from but is not limited to a website, an executable software program or a software application.

Example systems and methods may simultaneously involve more than one user or more than one data storage device or more than one host server or any combination thereof. A user may provide user input through any suitable input device or input mechanism such as but not limited to a keyboard, a mouse, a joystick, a touchpad, a virtual keyboard, a virtual data entry user interface, a virtual dial pad, a software or a program, a scanner, a remote device, a microphone, a webcam, a camera, a fingerprint scanner, a cave, pointing stick. The systems and methods can be practiced using any electronic device which may be connected to one or more of other electronic device with wires or wirelessly which may use technologies such as but not limited to, Bluetooth, WiFi, Wimax. This will also extend to use of the aforesaid technologies to provide an authentication key or access key or electronic device based unique key or any combination thereof.

The described embodiments may be implemented as a system, method, apparatus or article of manufacture using standard programming and/or engineering techniques related to software, firmware, hardware, or any combination thereof. The described operations may be implemented as code maintained in a “non-transitory, computer readable medium”, where a processor may read and execute the code from the non-transitory, computer readable medium. A non-transitory, computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMS, RAMS, DRAMS, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.).

Example embodiments and methods thus being described, it will be appreciated by one skilled in the art that example embodiments may be varied and substituted through routine experimentation while still falling within the scope of the following claims. For example, a variety of different software implementations and hardware configurations are compatible with example embodiments and methods simply through proper networking of example embodiments—and fall within the scope of the claims. Such variations are not to be regarded as departure from the scope of these claims.

What is claimed is:

1. An accounting exchange system configured to perform automated exchange and settling of accounting transactions, wherein the system comprises:
an interface configured to receive transaction information from at least one of a buyer and a seller, wherein the transaction information includes at least one of deliverables information and consideration information and at least one of buyer and seller information;
a processor programmed to transmit the transaction information between the buyer and the seller based on transmission rules; and
a database storing master identity information including at least one of user identities and deliverable information, wherein the processor is further programmed to compare the transaction information against the master identify information and transmit the transaction information in accordance with the transmission rules based on the comparison of the transaction information and the master identify information.

2. The system of claim 1, wherein the processor is further programmed to determine a receiving user of the transaction information based on the comparison and wherein the processor is further programmed to transmit the transaction information in a format of the receiving user.

3. The system of claim 2, further comprising:
a transaction bridge for the receiving user, wherein the processor is further programmed to transmit the transaction information in the format to the transaction bridge of the receiving user.

4. The system of claim 2, wherein the processor is further configured to add information to the transaction information from the master identity information based on the comparison.

5. The system of claim 1, wherein the processor is further configured to receive acceptance and approval data from the buyer and the seller.

6. The system of claim 1, wherein the master identity information further stores historical transaction information identifying past transactions, deliverables, consideration, and parties from previously-received transaction information.

7. The system of claim 6, wherein the processor is further configured to add information to the transaction information from the historical transaction information based on the comparison.

8. The system of claim 1, further comprising:
an unmatched transaction database storing information of failed previous transactions that were not transmitted between previous buyer and previous seller.

9. The system of claim 1, wherein the user identities include at least one of EIN, SSN, AESUIN, bank account number, and phone number of at least one of the buyer and the seller.

10. The system of claim 9, wherein the processor is further configured to transmit the transaction information to at least one of the buyer and the seller having the at least one of the EIN, SSN, AESUIN, bank account number, and phone number matching the transaction information as determined from the comparison.

11. The system of claim 9, wherein the processor is further configured to transmit the transaction information back to at an inputting buyer or seller to verify the at least one of the buyer and the seller having the at least one of the EIN, SSN, AESUIN, bank account number, and phone number matching the transaction information as determined from the comparison.

12. The system of claim 1, wherein the user identities are derived from publicly-accessible databases.

13. The system of claim 1, wherein the master identity information includes both user identities and deliverable information.

14. The system of claim 13, wherein the deliverable information includes codes used by the buyers and the sellers to identify and categorize the deliverables for tax purposes.

15. The system of claim 15, wherein the transaction information includes deliverables information, and wherein the processor is further configured to add the codes to the deliverables information based on the comparison.

16. The system of claim 15, wherein the processor is further programmed to return the added codes back to the buyer or the seller providing the transaction information.

17. A computer hardware processor coupled with an input interface and a master database storing historical transaction information and user information, wherein the computer hardware processor is configured to:
receive transaction information identifying deliverables and buyer or seller information;
compare the transaction information against the master database; and
transmit the transaction information to a buyer or a seller based on the comparison generating a match between the buyer or the seller and the buyer or seller information in the transaction information.

18. The computer hardware processor of claim 17, wherein the processor is further configured to:
add information to the transaction information from the master database based on the comparing; and
format the transaction information based on the matched buyer or seller.

19. The computer hardware processor of claim 18, wherein the master database further stores deliverable information and user format preferences, and wherein the formatting formats the transaction information based on format preferences for the matched buyer or seller.

20. The computer hardware processor of claim 19, wherein the processor is further configured to:
store the transaction information in the master database in association with the user information.
